(19) United States
(12) Patent Application Publication
(10) Pub. No.: US 2026/0106395 A1
(43) Pub. Date: Apr. 16, 2026

(54) CONNECTOR ASSEMBLY

(71) Applicant: P-TWO INDUSTRIES INC., Taoyuan City (TW)

(72) Inventors: Chun-Wei Chang, Taoyuan City (TW); Chih-Wei Huang, Taoyuan City (TW)

(21) Appl. No.: 19/291,361

(22) Filed: Aug. 5, 2025

(30) Foreign Application Priority Data
Oct. 11, 2024 (TW) 113138743

(51) Int. Cl. H01R 12/77; H01R 12/79

(52) U.S. Cl. CPC H01R 12/774; H01R 12/79

(57) ABSTRACT

A connector assembly is provided, which includes a first connector and a second connector. The first connector includes a first insulating housing having an accommodation space, a first metal shell and a nut member attached to the first metal shell, and the second connector can be inserted into the accommodation space in a first direction. The second connector includes a second insulating housing, a second metal shell and a latch member. The second insulating housing is formed with a locking hole. The latch member is formed with an elastic arm which is movable in a second direction perpendicular to the first direction and normally biased to a latched position. By means of a headed screw, the second connector can be locked onto the first connector. As such, a connector assembly with good operability and high reliability is achieved.

### CROSS-REFERENCES TO RELATED APPLICATIONS

This application claims the benefit of priority to Taiwanese Patent Application No. 113138743 filed on Oct. 11, 2024, which is hereby incorporated by reference in its entirety.

### BACKGROUND OF THE INVENTION

### Field of the Invention

The present invention relates to a connector assembly, and more particularly to a low-profile connector assembly having excellent operability.

### Descriptions of the Related Art

Taiwanese Utility Model Patent No. M644042U (Patent Document 1) discloses a connector for a flexible flat cable. The connector disclosed in Patent Document 1 has an actuator pivoted on an insulating housing, and the lock on the flexible flat cable (FFC) is released by pressing the body of the actuator and pivotably operating the actuator. However, this actuator has a certain thickness, making it difficult to achieve a low-profile connector.

Taiwanese Utility Model Patent No. M591717U (Patent Document 2) discloses a connector for a flexible flat cable. Patent Document 2 describes a connector housing functioning as a plug which is mounted on the insertion end of the flexible flat cable. This configuration allows the mating direction of the flexible flat cable with the easy-lock connector to be changed, facilitating automated insertion of the flexible flat cable into the easy-lock connector. Additionally, it enhances the operability and protection of the flexible flat cable. However, in the easy-lock connector disclosed in Patent Document 2, the flexible flat cable can only be released by simultaneously operating two separate locking members, resulting in poor operability for releasing the flexible flat cable. Since the operated portions of the locking members are positioned on the same side as the flexible flat cable, the release operation may be hindered by the presence of the flexible flat cable.

### SUMMARY OF THE INVENTION

One object of the present invention is to provide a connector assembly which has excellent operability and high reliability.

Another object of the present invention is to provide a connector assembly having a low profile and suitable for a compact or thin electronic machine.

A further object of the present invention is to provide a connector assembly capable of facilitating automated assembly.

According to an aspect of the present invention, a connector assembly is provided, which comprises a first connector and a second connector which is matable with the first connector in a first direction;
wherein the first connector comprises:
a first insulating housing, having an accommodation space, wherein the second connector is to be inserted into the accommodation space in the first direction in such a manner that at least a portion of the second connector is received in the accommodation space;
a plurality of contacts held by the first insulating housing, the plurality of contacts being arranged in a second direction perpendicular to the first direction, each contact including a contact portion positioned in the accommodation space and a connection terminal portion opposite to the contact portion; and
a first metal shell covering a portion of the first insulating housing, the first metal shell having two first engagement portions opposite to each other in the second direction; and
at least one nut member attached to the first metal shell, the at least one nut member having a threaded hole;
wherein the second connector comprises:
a second insulating housing;
a second metal shell covering a portion of the second insulating housing, the second metal shell being formed with a least one locking hole corresponding to the at least one nut member, the locking hole being provided to allow a shank of a headed screw to pass through and be screwed into the threaded hole of the at least one nut member; and
two latch members arranged spaced apart from each other in the second direction and held by the second insulating housing, each latch member having an elastic arm oriented in the first direction, the elastic arm being formed with a second engagement portion such that when the second connector is mated with the first connector, the second engagement portions of the latch members are respectively engaged with the first engagement portions.

According to the connector assembly of the present invention, the second insulating housing is formed with two guide posts extending in the first direction from a bottom surface of the second insulating housing for guiding insertion of the second connector into the accommodation space during a process of mating the second connector with the first connector.

According to the connector assembly of the present invention, each guide post has a chamfered end.

According to the connector assembly of the present invention, the first insulating housing has with two guide post holes for respectively receiving the two guide posts.

According to the connector assembly of the present invention, the elastic arms are respectively and partially sheltered by the guide posts.

According to the connector assembly of the present invention, each elastic arm is U-shaped.

According to the connector assembly of the present invention, the second metal shell comprises an upper shell and a lower shell, the upper shell is disposed on an upper side of the second insulating housing, and the lower shell is disposed on a lower side of the second insulating housing; the second connector further comprises a flat connection object including a head portion and a plurality of electrode portions formed on the head portion, wherein the head portion of the flat connection object is accommodated in a space defined by the second insulating housing and the lower shell, and the plurality of electrode portions are exposed from the lower shell such that when the second connector is mated with the first connector, the plurality of electrode portions are brought into electrical contact with the plurality of contacts of the first connector respectively.

According to the connector assembly of the present invention, the at least one nut member is attached to the first metal shell by soldering or welding.

According to the connector assembly of the present invention, the threaded hole is oriented such that a central axis of the thread hole is parallel to the first direction.

According to the connector assembly of the present invention, the second engagement portion has a rounded convex shape in a cross-section perpendicular to a third direction perpendicular to the first direction and the second direction.

According to the connector assembly of the present invention, a process of mating the second connector with the first connector can be easily performed in an automated manner without use of a complex machine. The engagement between the first connector and the second connector can be securely locked, thereby ensuring a reliable connection.

According to the connector assembly of the present invention, the size of the connector assembly in the third direction (the front-rear direction) can be reduced.

Furthermore, since the latch members are not provided on the first connector, which serves as a board-mounted connector, maintenance complexity is significantly reduced.

The above and other objects and advantages of the present invention will become apparent from the accompanying drawings and the following detailed description.

### BRIEF DESCRIPTION OF THE DRAWINGS

FIG. 1 is a perspective view of the connector assembly in a mated state according to the embodiment of the present invention.

FIG. 2 is a perspective view of the connector assembly in an unmated state according to the embodiment of the present invention.

FIG. 3 is a perspective view of the receptacle connector according to the embodiment of the present invention.

FIG. 4 is an exploded perspective view of the receptacle connector according to the embodiment of the present invention.

FIG. 5 is a perspective view of a first insulating housing of the receptacle connector according to the embodiment of the present invention.

FIG. 6 is a perspective view of a plurality of contacts of the receptacle connector according to the embodiment of the present invention.

FIG. 7 is a perspective view of a first metal shell of the receptacle connector according to the embodiment of the present invention.

FIG. 8 is a perspective view of a nut member of the receptacle connector according to the embodiment of the present invention.

FIG. 9 is a perspective view of the plug connector according to the embodiment of the present invention.

FIG. 10 is another perspective view of the plug connector according to the embodiment of the present invention.

FIG. 11 is an exploded perspective view of the plug connector according to the embodiment of the present invention.

FIG. 12 is a perspective view of a second insulating housing of the plug connector according to the embodiment of the present invention.

FIG. 13 is a perspective view of an upper shell of the plug connector according to the embodiment of the present invention.

FIG. 14 is a top view of the connector assembly in a locked state according to the embodiment of the present invention.

FIG. 15 is a sectional view taken along the line AA in FIG. 14.

### DETAILED DESCRIPTION OF THE PREFERRED EMBODIMENT

The connector assembly according to the embodiment of the present invention will be described with reference to the drawings. In the drawings, the same components or components with similar functions are denoted by the same reference numerals. The drawings are not necessarily drawn to scale.

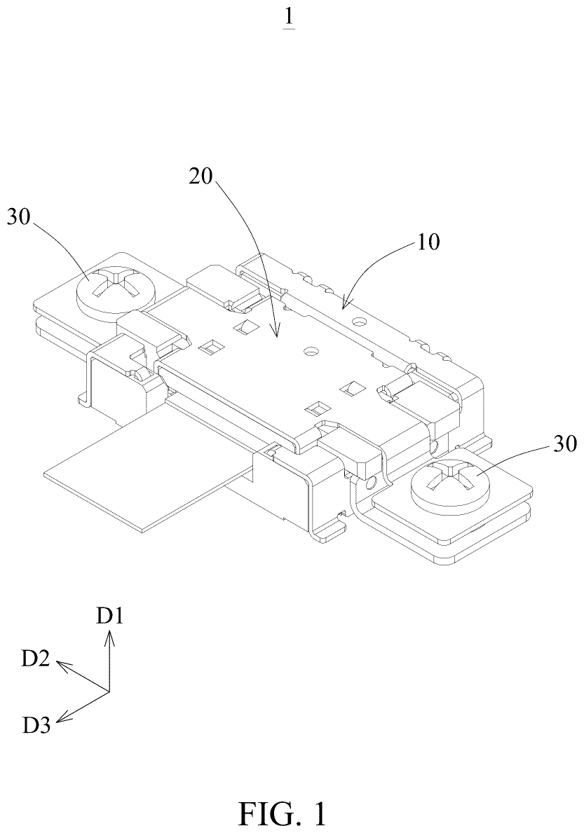

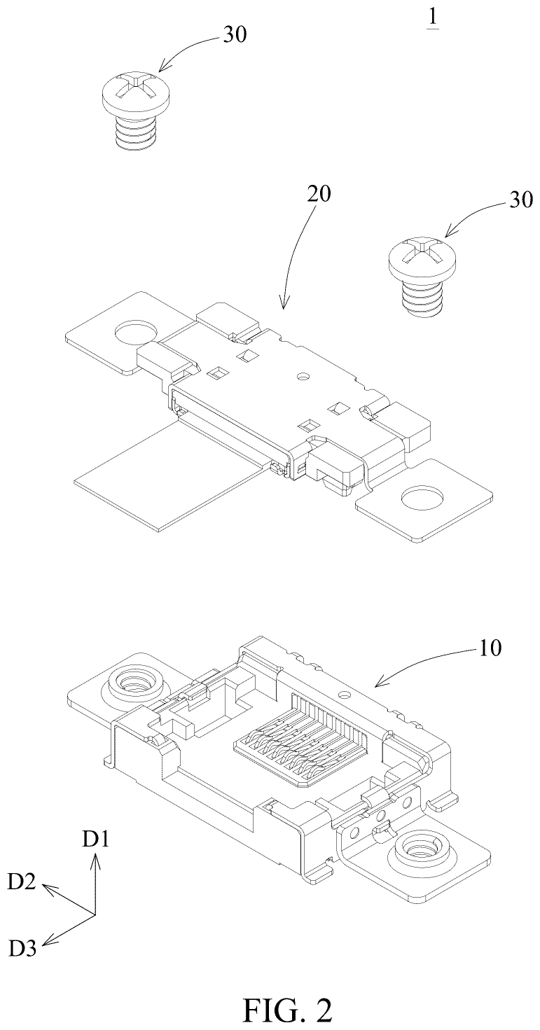

The connector assembly according to the embodiment of the present invention is described by referring to FIGS. 1 and 2. FIG. 1 is a perspective view of the connector assembly in a mated state according to the embodiment of the present invention, and FIG. 2 is a perspective view of the connector assembly in an unmated state according to the embodiment of the present invention. The connector assembly is entirely denoted by the reference numeral 1. The connector assembly 1 comprises a receptacle connector 10 as a first connector and a plug connector 20 as a second connector. The plug connector 20 can be mated with the receptacle connector 10 in a first direction D1. In the mated state, the plug connector 20 is locked onto the receptacle connector 10 by means of two headed screws 30.

In this embodiment, the receptacle connector 10 is a board-mounted connector, while the plug connector 20 is formed by attaching a connector housing (i.e., a second insulating housing) and a connector shell (i.e., a second metal shell) to a head portion of a flat connection object such as a flexible flat cable (FFC) or a flexible printed circuit (FPC). In the description, the assembly composed of the connector housing (i.e., the second insulating housing), the connector shell (i.e., the second metal shell) and the flat connection object is referred to as the second connector or the plug connector.

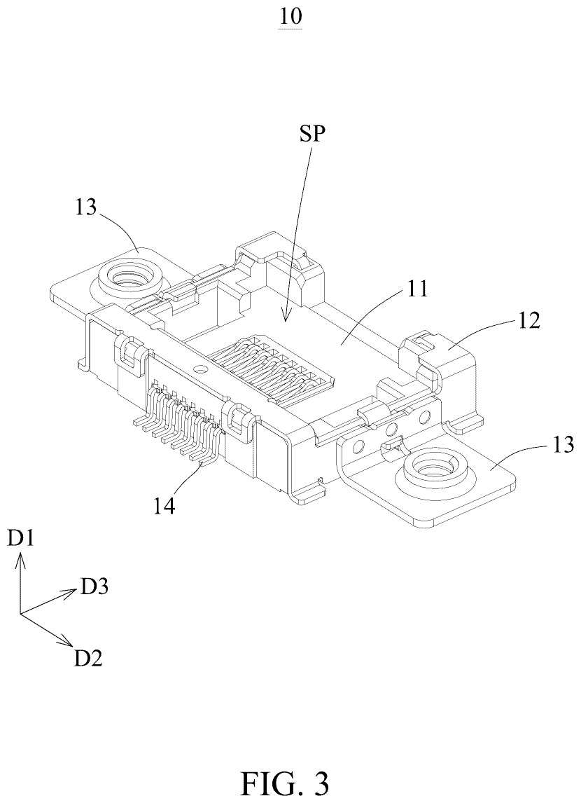

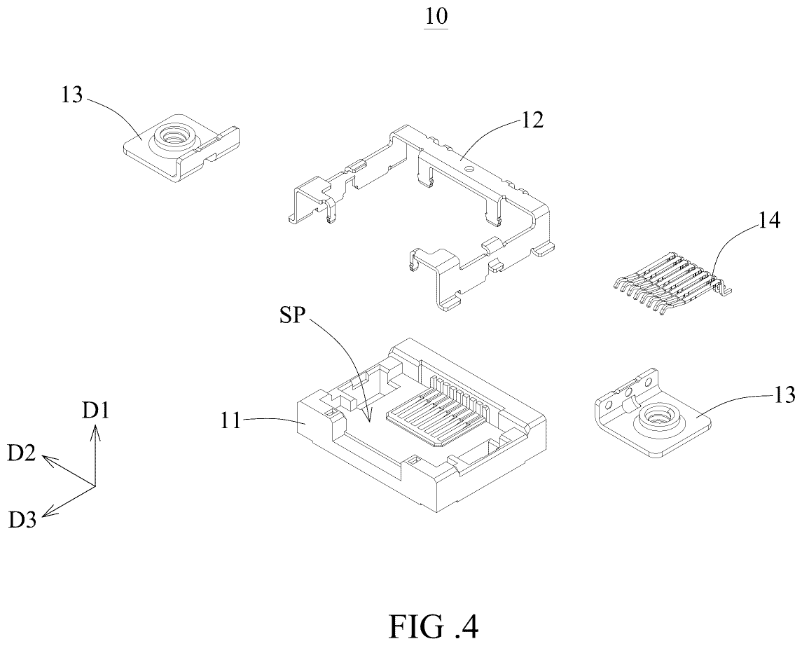

The receptacle connector 10 of the embodiment of the present invention is described by referring to FIGS. 3 and 4. FIG. 3 is a perspective view of the receptacle connector 10 according to the embodiment of the present invention, and FIG. 4 is an exploded perspective view of the receptacle connector 10 according to the embodiment of the present invention. The receptacle connector 10 includes a first insulating housing 11, a first metal shell 12, two nut members 13 and a plurality of contacts 14.

The plug connector 20 can be inserted into the receptacle connector 10 in the first direction D1 (i.e., the height direction or the mating direction). The flat connection object forming a part of the plug connector 20 may be a flexible flat cable (FFC) or a flexible printed circuit (FPC), but the present invention is not limited thereto. The flat connection object may be a card board. The flat connection object includes a plurality of electrode portions formed on the head portion of the flat connecting object. The plug connector 20 may be a wire-end connector in a wire-to-board connector assembly.

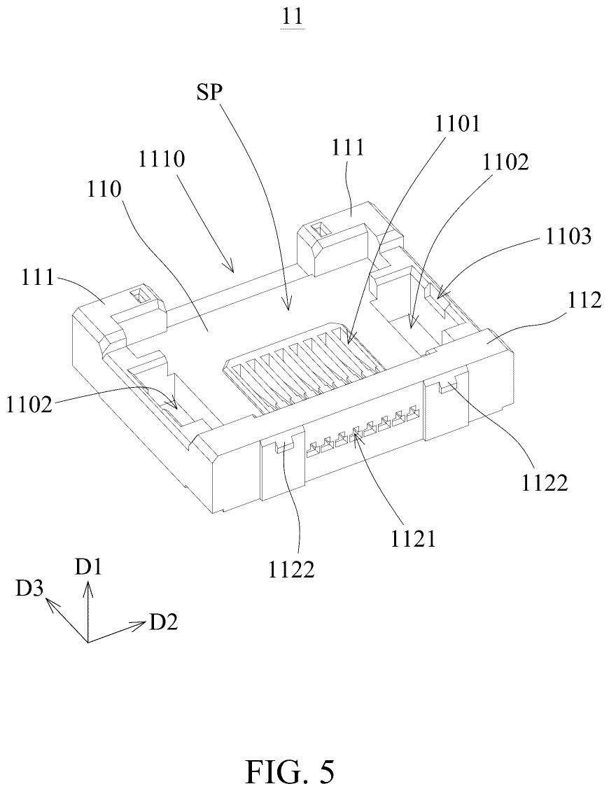

FIG. 5 is a perspective view of the first insulating housing 11. The configuration of the first insulating housing 11 is described by referring to FIG. 5. The first insulating housing 11 is made of insulating synthetic resin or polymer material. The first insulating housing 11 includes a flat rectangular body 110 and a peripheral wall formed on the edge of the flat rectangular body 110. The flat rectangular body 110 and the peripheral wall define an accommodation space SP. The peripheral wall consists of a front wall portion 111 and a rear wall portion 112 opposite to the front wall portion 111.

The flat rectangular body 110 is formed with a plurality of contact grooves 1101. The contact grooves 1101 are arranged in a second direction D2 (i.e., the width direction) perpendicular to the first direction D1 and are spaced from each other. The flat rectangular body 110 has two guide post openings 1102 spaced from each other in the second direction D2. The upper edge of each guide post opening 1102 is chamfered. A recess 1103 is formed at the upper edge of the inner surface of each guide post opening 1102.

The front wall portion 111 is formed with a notch 1110. The notch 1110 is provided for preventing interference between the front wall portion 111 and the flat connection object.

The rear wall portion 112 is formed with a plurality of contact holding holes 1121. Each contact holding hole 1121 is communicated with a respective contact groove 1101. The rear wall portion 112 is further formed with two protrusions 1122 for attachment of the first metal shell 12 to the first insulating housing 11.

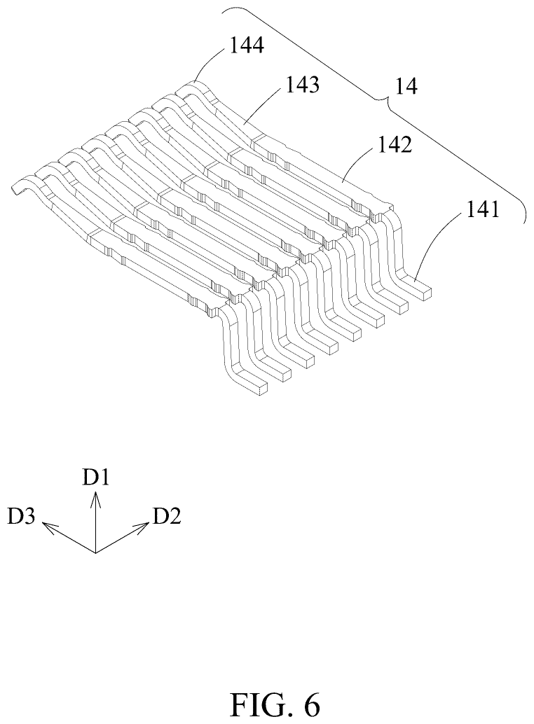

FIG. 6 is a perspective view of the plurality of contacts 14. The contacts 14 are arranged in one row in the second direction D2 and are held by the first insulating housing 11. Each contact 14 is made of copper or a copper alloy. Each contact 14 includes a connection terminal portion 141, a held portion 142, a contact arm 143 and a contact portion 144. The contact arm 143 extends from one end of the held portion 142, while the connection terminal portion 141 extends from the other end of the held portion 142. The held portion 142 is formed with a barb structure and is inserted into the contact holding hole 1121 in an interference-fit manner. The contact portion 144 is formed on a distant end of the contact arm 143. Each contact arm 143 extends substantially in a third direction D3 (i.e., the front-rear direction) perpendicular to the first direction D1 and the second direction D2 in a respective contact groove 1101 and extends into the accommodation space SP, so that the contact portion 144 is brought into contact with the electrode portion formed on the flat connection object. The connection terminal portion 141 protrudes from the first insulating housing 11 and can be soldered to the solder pad formed on a circuit board by using surface mount technology (SMT). When the receptacle connector 10 is mounted on a circuit board, the soldering condition of the connection terminal portion 141 can be inspected by using automatic optical inspection (AOI).

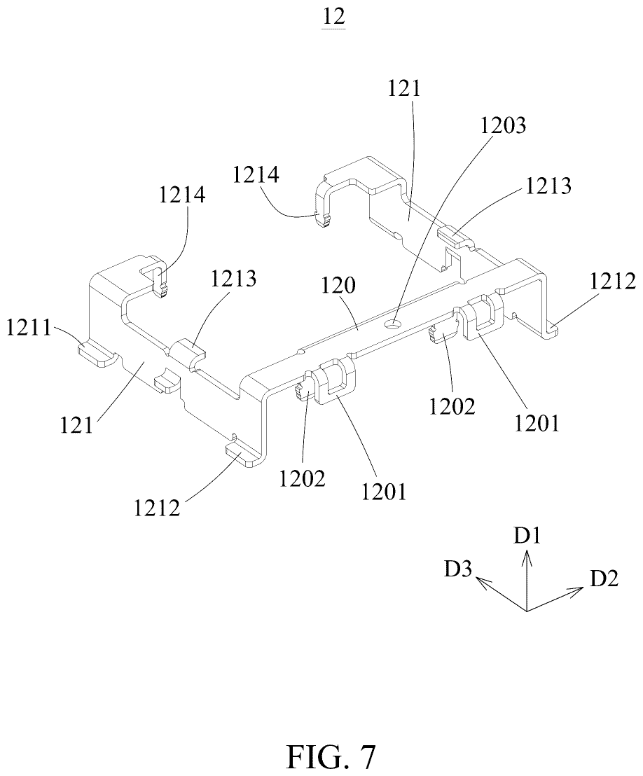

FIG. 7 is a perspective view of the first metal shell 12. The first metal shell 12 is formed by stamping and bending a metal plate (e.g., a plate made of stainless steel or phosphor bronze). The first metal shell 12 is configured to have a generally U-shape when viewed from the first direction D1. The first metal shell 12 includes two lateral shell portions 121 and a connecting portion 120 which connects the two lateral shell portions 121.

The lower edge of each lateral shell portion 121 includes a first soldered portion 1211 adjacent to the front end of the lateral shell portion 121 and a second soldered portion 1212 adjacent to the rear end of the lateral shell portion 121. The first soldered portion 1211 and the second soldered portion 1212 can be soldered to the solder pads formed on a circuit board by using surface mount technology (SMT). In this manner, the receptacle connector 10 can be firmly mounted on the circuit board. The upper edge of each lateral shell portion 121 has a stopper portion 1213, which serves as a first engagement portion, located centrally. The distant end of each lateral shell portion 121 is formed with a held portion 1214. The held portion 1214 is formed with a barb structure and is inserted into a holding hole formed in the first insulating housing 11 in an interference-fit manner. In this way, the distant end of the lateral shell portion 121 is attached to the first insulating housing 11.

The rear edge of the connecting portion 120 is formed with an engaging portion 1201 for engagement with the protrusion 1122 formed on the rear wall portion 112 of the first insulating housing 11. The inner edge of the connecting portion 120 is formed with a held portion 1202. The held portion 1202 is formed with a barb structure and is inserted into a holding hole formed in the first insulating housing 11 in an interference-fit manner. In this way, the connecting portion 120 is attached to the first insulating housing 11. By engagement of the engaging portion 1201 with the protrusion 1122, the first metal shell 12 is prevented from being detached from the first insulating housing 11.

The connecting portion 120 is formed with an alignment hole 1203. When a robotic arm picks up the plug connector 20 and aligns it with the accommodation space SP of the receptacle connector 10, the alignment hole 1203 serves as an alignment mark recognizable by a machine vision system.

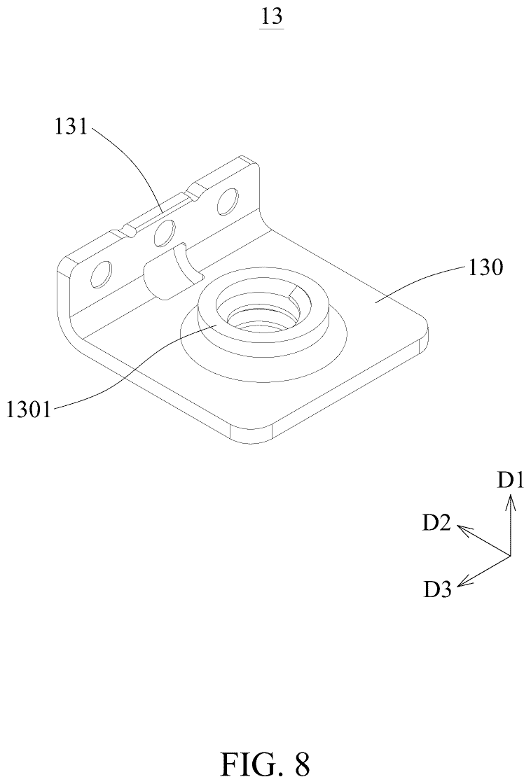

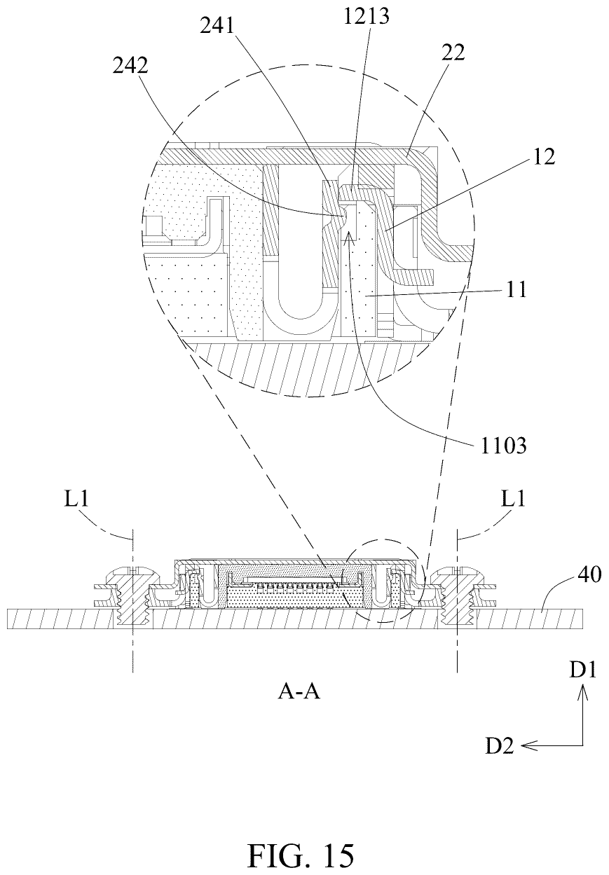

FIG. 8 is a perspective view of the nut member 13. The nut member 13 includes a rectangular plate-shaped body 130 and a fixed portion 131. The plate-shaped body 130 is formed with a sleeve portion 1301 having a threaded hole. The plate-shaped body 130 is oriented perpendicular to the first direction D1, such that the central axis L1 of the threaded hole (as shown in FIG. 15) is parallel to the first direction D1. The fixed portion 131 is oriented perpendicular to the second direction D2. The fixed portion 131 is fixed to the lateral shell portion 121 of the first metal shell 12 by soldering or welding, for example, laser beam welding.

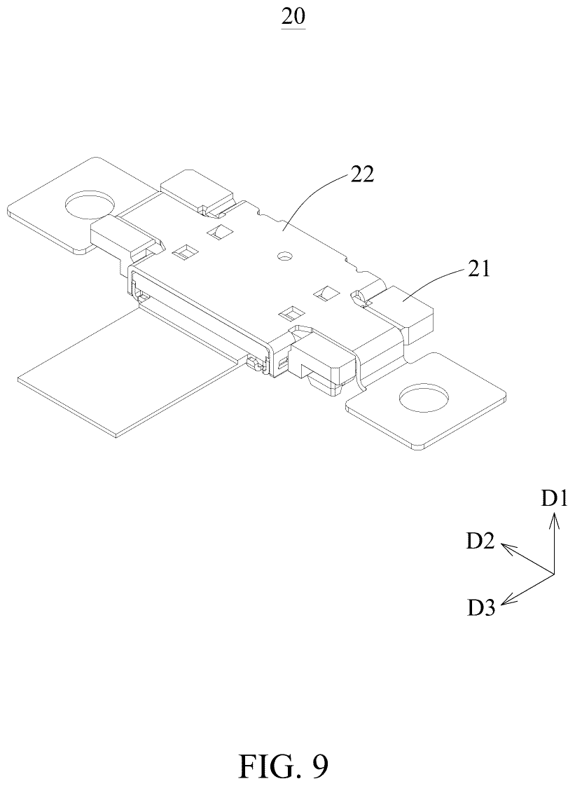

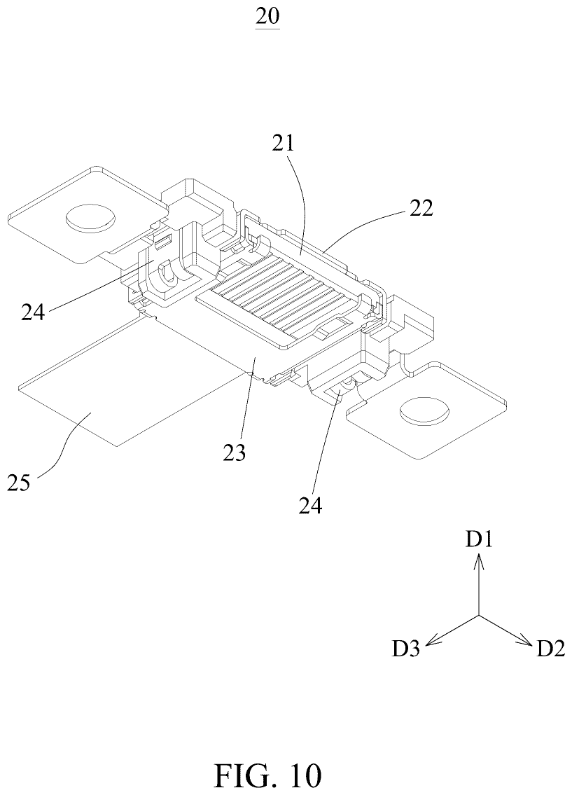

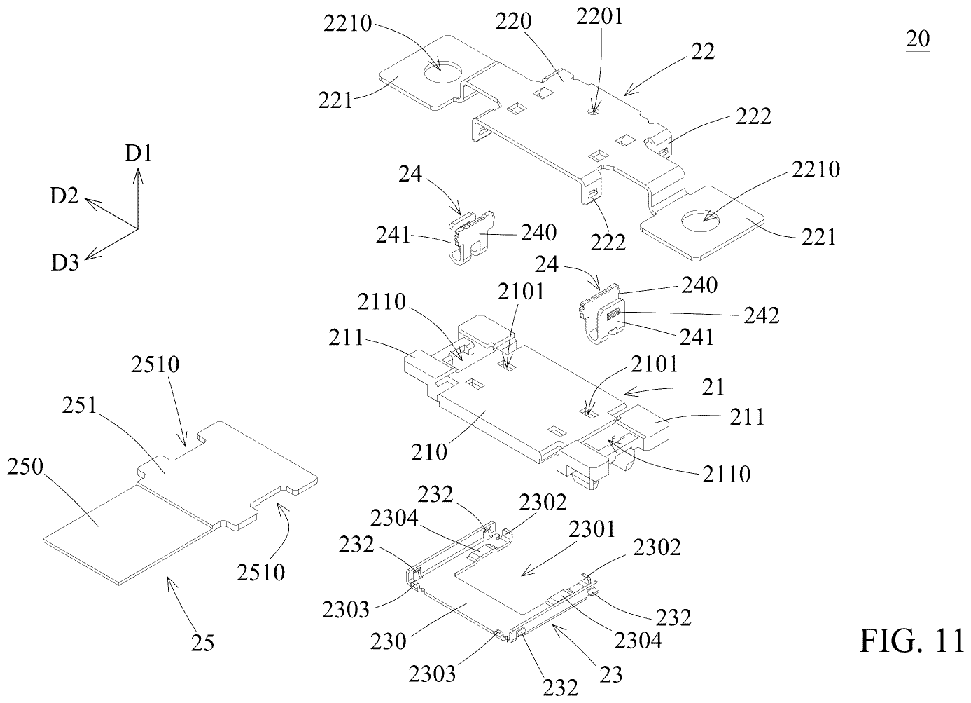

The plug connector 20 of the embodiment of the present invention is described by referring to FIGS. 9, 10 and 11. FIG. 9 is a perspective view of the plug connector 20 according to the embodiment of the present invention, FIG. 10 is another perspective view of the plug connector 20 according to the embodiment, and FIG. 11 is an exploded perspective view of the plug connector 20 according to the embodiment of the present invention. The plug connector 20 includes a second insulating housing 21, a second metal shell, two latch members 24 and a flat connection object 25. The second metal shell is composed of an upper shell 22 and a lower shell 23.

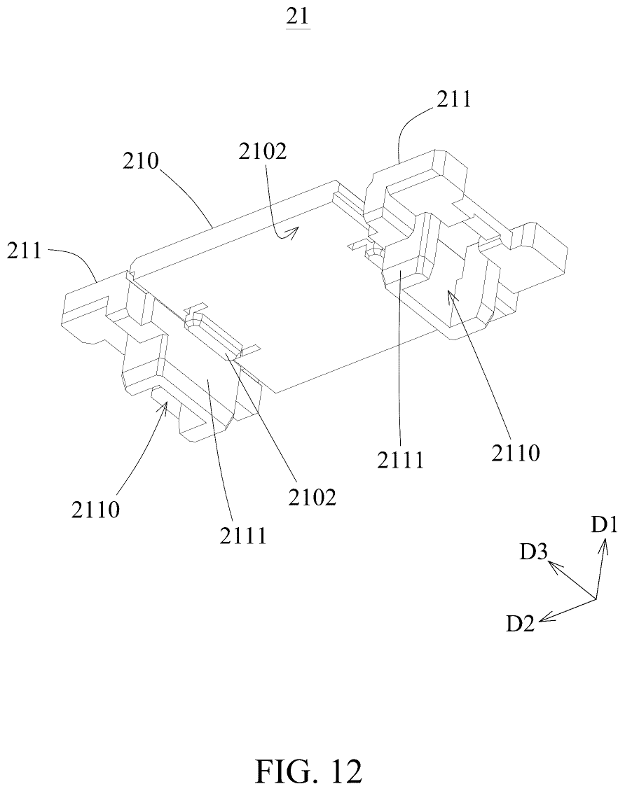

The second insulating housing 21 is described by referring to FIGS. 11 and 12. FIG. 12 is a perspective view of the second insulating housing 21. The second insulating housing 21 is made of insulating synthetic resin or polymer material. The second insulating housing 21 includes a flat rectangular body 210 and two lateral portions 211 respectively located on both sides of the flat rectangular body 210 in the second direction D2. Four positioning holes 2101 are formed on the upper surface of the flat rectangular body 210 for positioning the upper shell 22. Two protrusions 2102 are formed on the lower surface of the flat rectangular body 210 for engagement with two notches 2510 (which will be described later) of the flat connection object 25. Each lateral portion 211 is formed with a receiving opening 2110 for receiving the latch member 24. As shown in FIG. 12, each lateral portion 211 is further formed with a guide post 2111 extending downward in the first direction D1 from the lower surface of the lateral portion 211. The guide posts 2111 are provided for guiding the insertion of the plug connector 20 and positioning the plug connector 20.

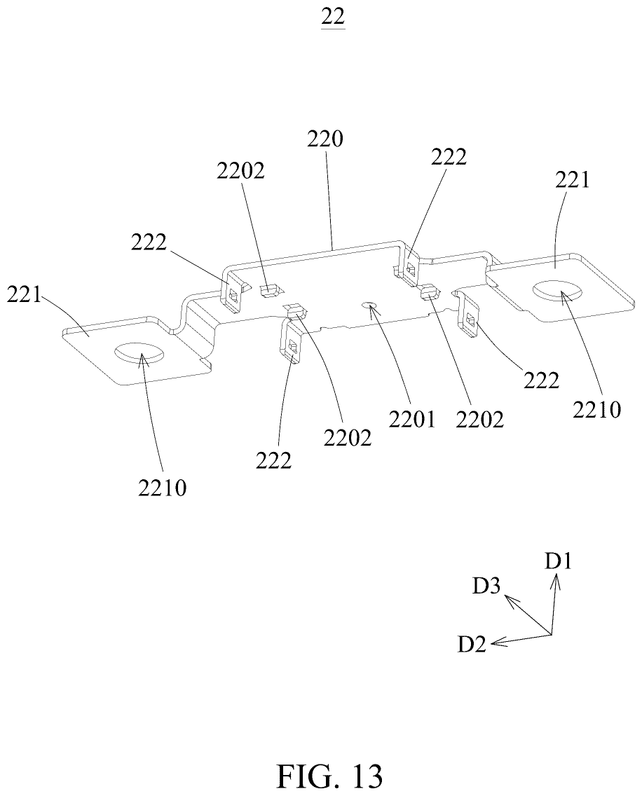

The upper shell 22 and the lower shell 23 are described by referring to FIGS. 11 and 13. FIG. 13 is a perspective view of the upper shell 22. The details of the upper shell 22 are shown in FIGS. 11 and 13, while the details of the lower shell 23 are shown in FIG. 11. The upper shell 22 and the lower shell 23 are formed by stamping and bending a metal plate (e.g., a plate made of stainless steel or phosphor bronze). The upper shell 22 is disposed on the upper side of the second insulating housing 21, while the lower shell 23 is disposed on the lower side of the second insulating housing 21.

The upper shell 22 includes a body portion 220. The body portion 220 of the upper shell 22 has a flat surface which can be adsorbed by a vacuum nozzle. The body portion 220 of the upper shell 22 is formed with an alignment hole 2201. Similar to the alignment hole 1203, the alignment hole 2201 serves as an alignment mark recognizable by a machine vision system. Two lateral extension portions 221 are respectively formed on two opposite lateral edges of the body portion 220 of the upper shell 22 in the second direction D2. Each lateral extension portion 221 is formed with a locking hole 2210 corresponding to the threaded hole of the nut member 13. In the mated state of the connector assembly, the locking holes 2210 are substantially aligned with the threaded holes of the nut members 13. At this time, the shaft portion of the headed screw 30 can be screwed into the threaded hole, such that the lateral extension portion 221 is clamped between the head of the headed screw 30 and the nut member 13.

Two engaging portions 222 are formed on each lateral edge of the body portion 220 of the upper shell 22. The lower surface of the upper shell 22 is formed with four positioning tabs 2202 respectively corresponding to the four positioning holes 2101. By inserting the positioning tabs 2202 into the positioning holes 2101, movement of the upper shell 22 with respect to the second insulating housing 21 in a plane perpendicular to the first direction D1 is prevented.

The lower shell 23 includes a body portion 230. The body portion 230 has a notch 2301, through which a portion of the bottom surface of the flat connection object 25 is exposed. Two first limiting portions 2302 are formed on the front edge of the lower shell 23, and two second limiting portions 2303 are formed on the rear edge of the lower shell 23. Two protruding portions 232 are formed on each lateral edge of the lower shell 23. By engaging the protruding portions 232 with the engaging portions 222, the upper shell 22 and the lower shell 23 are securely attached to each other so as to form the second metal shell.

The body portion 230 of the lower shell 23 is further formed with two bosses 2304 serving as gap adjusters. The bosses 2304 prevent the flat connection object 25 from wobbling up and down with respect to the second insulating housing 21 and the lower shell 23.

As shown in FIG. 11, each latch member 24 includes a held portion 240 and a U-shaped elastic arm 241. The held portion 240 is formed with a barb structure. The held portion 240 is inserted into a receiving hole 2110 in an interference-fit manner so that the latch member 24 is retained in the receiving hole 2110. At this time, the U-shaped elastic arm 241 is partially sheltered by the guide post 2111, while a portion of the U-shaped elastic arm 241 remains unsheltered. The guide post 2111 is capable of protecting the U-shaped elastic arm 241 and preventing the U-shaped elastic arm 241 from being unintentionally impacted. The U-shaped elastic arm 241 is oriented in the first direction D1 and is configured to be movable in the second direction D2 and constantly biased to a latched position. The U-shaped elastic arm 241 is formed with a rib 242 serving as a second engagement portion so that when the plug connector 20 is mated with the receptacle connector 10, the rib 242 (the second engagement portion) is engaged with the stopper portion 1213 (the first engagement portion) formed on the first metal shell for preventing the plug connector 20 from being removed from the receptacle connector 10.

The flat connection object 25 is described by referring to FIG. 11. As shown in FIG. 11, the flat connection object 25 includes a head portion 251 and an extension portion 250. A notch 2510 is formed on each lateral edge of the head portion 251. In this embodiment, the flat connection object 25 is a flexible flat fable (FFC). The other end of the extension portion may be formed with another head portion. The bottom surface of the head portion 251 is formed with a plurality of electrode portions arranged in the second direction D2 adjacent to the insertion end or front edge. The head portion 251 of the flat connecting object 25 is received within a space defined by the second insulating housing 21 and the lower shell 23. These electrode portions are exposed through the notch 2301 of the lower shell 23 so that when the plug connector 20 is mated with the receptacle connector 10, these electrode portions are brought into electrical contact with the contacts 13 of the receptacle connector 10 respectively.

The first limiting portions 2302 and the second limiting portions 2303 formed on the body portion 230 of the lower shell 23 are respectively abut against the front edge and rear edge of the head portion 251 of the flat connection object 25, preventing movement of the flat connection object 25 with respect to the second insulating housing in the third direction D3. The protrusion 2102 is abut against the inner edge of the notch 2510 of the flat connection object 25, preventing movement of the flat connection object 25 with respect to the second insulating housing in the second direction D2.

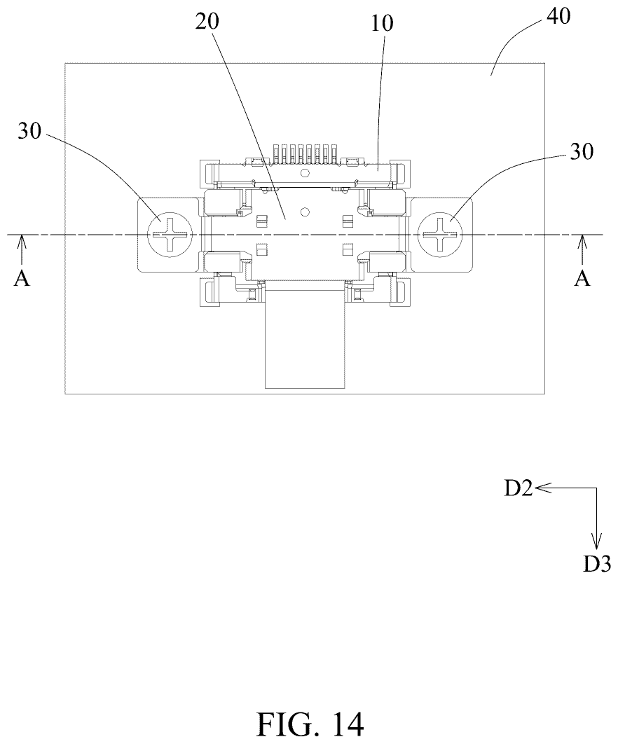

FIG. 14 is a top view of the connector assembly 1 in a locked state according to the embodiment of the present invention, wherein the receptacle connector 10 is mounted on a circuit board 40. FIG. 15 is a sectional view taken along the line AA in FIG. 14. As shown in FIG. 15, the rib 242 serving as the second engagement portion is engaged with the stopper portion 1213 serving as the first engagement portion. The rib 242 is configured to have a rounded convex shape in a cross-section perpendicular to the third direction D3.

During removal of the plug connector 20 from the receptacle connector 10 in the first direction D1, the shape of the rib 242 enables interaction between the rib 242 and the stopper portion 1213 to bias the U-shaped elastic arm 241 away from the latched position, allowing the plug connector 20 to be detached from the receptacle connector 10. Accordingly, no additional operated member is required to bias the U-shaped elastic arm away from the latched position.

The connector assembly according to the present invention indeed has the advantages of low profile and good operability. In addition, the connector assembly according to the present invention is particularly suitable for use in a compact or thin electronic machine. Additionally, the connector assembly according to the present invention is also suitable for automated assembly of a flat connection object and board-mount connector.

While this invention has been described in reference to a preferred embodiment, it should be understood that numerous changes and modifications could be made within the scope of the inventive concepts described. Accordingly, it is intended that the invention not be limited to the disclosed embodiment, but that it have the full scope permitted by the language of the following claims.

What is claimed is:

1. A connector assembly comprising a first connector and a second connector which is matable with the first connector in a first direction;
wherein the first connector comprises:
a first insulating housing, having an accommodation space, wherein the second connector is to be inserted into the accommodation space in the first direction in such a manner that at least a portion of the second connector is received in the accommodation space;
a plurality of contacts held by the first insulating housing, the plurality of contacts being arranged in a second direction perpendicular to the first direction, each contact including a contact portion positioned in the accommodation space and a connection terminal portion opposite to the contact portion; and
a first metal shell covering a portion of the first insulating housing, the first metal shell having two first engagement portions opposite to each other in the second direction; and
at least one nut member attached to the first metal shell, the at least one nut member having a threaded hole;
wherein the second connector comprises:
a second insulating housing;
a second metal shell covering a portion of the second insulating housing, the second metal shell being formed with a least one locking hole corresponding to the at least one nut member, the locking hole being provided to allow a shank of a headed screw to pass through and be screwed into the threaded hole of the at least one nut member; and
two latch members arranged spaced apart from each other in the second direction and held by the second insulating housing, each latch member having an elastic arm oriented in the first direction, the elastic arm being formed with a second engagement portion such that when the second connector is mated with the first connector, the second engagement portions of the latch members are respectively engaged with the first engagement portions.

2. The connector assembly of claim 1, wherein the second insulating housing is formed with two guide posts extending in the first direction from a bottom surface of the second insulating housing for guiding insertion of the second connector into the accommodation space during a process of mating the second connector with the first connector.

3. The connector assembly of claim 2, wherein each guide post has a chamfered end.

4. The connector assembly of claim 2, wherein the first insulating housing has with two guide post holes for respectively receiving the two guide posts.

5. The connector assembly of claim 1, wherein the elastic arms are respectively and partially sheltered by the guide posts.

6. The connector assembly of claim 1, wherein each elastic arm is U-shaped.

7. The connector assembly of claim 1, wherein the second metal shell comprises an upper shell and a lower shell, the upper shell is disposed on an upper side of the second insulating housing, and the lower shell is disposed on a lower side of the second insulating housing; the second connector further comprises a flat connection object including a head portion and a plurality of electrode portions formed on the head portion, wherein the head portion of the flat connection object is accommodated in a space defined by the second insulating housing and the lower shell, and the plurality of electrode portions are exposed from the lower shell such that when the second connector is mated with the first connector, the plurality of electrode portions are brought into electrical contact with the plurality of contacts of the first connector respectively.

8. The connector assembly of claim 1, wherein the at least one nut member is attached to the first metal shell by soldering or welding.

9. The connector assembly of claim 1, wherein the threaded hole is oriented such that a central axis of the thread hole is parallel to the first direction.

10. The connector assembly of claim 1, wherein the second engagement portion has a rounded convex shape in a cross-section perpendicular to a third direction perpendicular to the first direction and the second direction.
